(19) United States
(12) Patent Application Publication
(10) Pub. No.: US 2005/0214539 A1
(43) Pub. Date: Sep. 29, 2005

(54) Porous carbon structures and methods

(75) Inventors: Jackie Y. Ying, Winchester, MA (US); Javier Garcia-Martinez, Alicante (ES); Thomas M. Lancaster, Somerville, MA (US)

Correspondence Address: Timothy J. Oyer, Ph.D.;Wolf, Greenfield & Sacks, P.C., 600 Atlantic Avenue, Boston, MA, 02210, US

(73) Assignee: Massachusetts Institute of Technology, Cambridge, MA (US)

(21) Appl. No.: 10/823,084

(22) Filed: Apr. 13, 2004

Related U.S. Application Data
(60) Provisional application No. 60/556,976, filed on Mar. 26, 2004.

(51) Int. Cl. B32B 9/00

(52) U.S. Cl. 428/408; 428/304.4

(57) ABSTRACT

Methods for making porous articles are described, along with articles and structures which can be made by these methods. The methods typically involve polymerization of a carbon-containing precursor in the presence of an amphiphilic molecular structure, followed by carbonization to make a final product. Articles of the invention are generally porous, carbon-containing, and can have one or any number of features including crystallinity, electrical conductivity, and porosity of a specific and advantageous nature.

### RELATED APPLICATIONS

This application claims priority under 35 U.S.C. § 119(e) to U.S. Provisional Application Ser. No. 60/556,976, entitled “POROUS CARBON STRUCTURES AND METHODS,” filed on Mar. 26, 2004, which is herein incorporated by reference in its entirety.

### FIELD OF THE INVENTION

The present invention relates generally to porous carbon material, and more particularly to crystalline porous carbon material having good electrical conductivity and other features, as well as method for making porous carbon material.

### BACKGROUND OF THE INVENTION

Carbon is used in a variety of applications, from nanotechnology to energy production, and it can be found in a range of natural forms including coal, diamond, and graphite. Man-made forms of carbon, such as glassy carbon, are used in a number of applications, but glassy carbon has little or no porosity, and porosity is important in many applications. Other types of porous carbon, such as activated carbon, have been used extensively as separation agents and catalyst supports due to their high surface areas. Macroporous carbon (containing a substantial number of pores larger than 100 nm) is known, but its use is limited for many applications by its low surface area.

Activated carbon is generally formed via pyrolysis of organic carbon precursor products in the presence of an activating agent, resulting in a high surface area material useful for water treatment, catalyst supports, separations, etc. Pyrolysis typically results in the removal of non-carbon substances and selectively oxidizes the carbon material, producing a high surface area material including surface functional groups useful for immobilization of other species for a variety of purposes. Activated carbon typically has a broad pore size range mainly in the microporous range. Typical characteristics that can be considered drawbacks include the fact that activated carbon typically is a powder in form, is non-crystalline, and is generally not conductive. The “activated” aspect of this material defines the process of forming pores in carbon. One technique involves controlled burning of pores within carbon under an atmosphere of controlled oxidation level so as to direct pore formation. Chemical processes, such as chemical intercalation of graphite layers, can be accomplished by, for example, intercalation with potassium and subsequent reaction to expand pores between those layers.

Aerogels and xerogels are generally high-surface-area, porous materials, some of which can be carbon. Carbon aerogels and xerogels are typically non-crystalline, low-electrically-conductive powders of cross-linked polymers which create voids defining the porous structure. These materials typically are made in a process similar to the sol gel process where a polymerizable carbon precursor forms sols or tiny droplets of carbon that connect and gel under predetermined chemical conditions. Surfactants typically are not used in the formation of these materials. Supercritical drying and/or solvent replacement, relatively expensive processes, typically are used to maintain porosity in a desired size range in a production process.

Templated mesoporous carbon is a material made, typically, by coating a silica precursor with carbon, allowing the carbon to polymerize on the surface of the silica, and then etching the silica from the material resulting in porous carbon. In this process, as well as in processes in making many carbon structures, the carbon must be heat-treated in an inert atmosphere to make it rigid enough to maintain its porous structure during subsequent treatment steps. In templated mesoporous carbon, this rigidifying step typically takes place prior to removal of silica.

U.S. Pat. No. 6,297,293, issued Oct. 2, 2001 to Bell, et al. describes a process for forming carbon material involving mixing a carbon precursor material with an ionic surfactant and a catalyst to form a microemulsion, and polymerizing the carbon precursor. Heating is used to remove amphiphilic molecules to form particulate material which, upon collapse, define pores resulting from interstitial spaces between the collapsed particles.

U.S. Pat. No. 4,609,972, issued Sep. 2, 1986 to Edeling, et al., describes a process for producing carbon material involving mixing a furfuryl alcohol carbon precursor with catalyst and a fatty acid salt, polymerizing the carbon precursor, and heating the material to decompose the fatty acid salt to produce carbon dioxide which expands and defines voids in the final material.

Carbon nanotubes are tubes formed of graphitic layers or graphite-like material, and can be single-walled or multi-walled. Carbon nanotubes generally are crystalline and electrically conductive. Although interconnected or “branched” carbon nanotubes are known, carbon nanotubes are not known to exhibit porosity. Because of the unique structure of carbon nanotubes, they almost invariably exhibit a Raman vibrational mode characterized as a “radial breathing mode” as described by M. S. Dresselhaus, et al., Science of Fullerenes and Carbon Nanotubes (Academic Press, New York, N.Y. 1996). Another characteristic of carbon nanotubes is that, because of their non-porous structure, their absorption of nitrogen, specifically their nitrogen adsorption isotherm at 77K, differs substantially from that of porous materials.

Although a wide variety of carbon materials, including porous materials, are known, many of these materials cannot be produced in porous form or, if porous, might not be able to be produced with pores of a size and/or uniformity desired for a particular application; may not be crystalline, may not be electrically conductive, may be of low or zero crystallinity, might not have net shape formability (e.g., may be available only in powder form), and/or may be obtainable only by relatively expensive and complicated techniques. In many cases, one or more of the above issues can define drawbacks for a particular application, and it may be desirable to make materials with controlled properties, free of one or more of the above drawbacks, and in particular materials including high carbon content. Specifically, improved porous materials are needed for a variety of purposes including catalyst supports, conductive materials, etc.

### BRIEF DESCRIPTION OF DRAWINGS

FIG. 1. Nitrogen adsorption-desorption isotherms and BJH desorption mesopore size distributions (inset) of CNF materials prepared under the same synthesis conditions with hexadecanol (blue), octadecanol (red) and docosanol (green) as the surfactants. A weight ratio of 1:1 was used for the furfuryl alcohol-surfactant mixtures.

FIG. 2: Examples of articles made in accordance with the invention.

### SUMMARY OF THE INVENTION

The present invention relates to methods for making porous articles, along with articles and structures which can be made by these methods.

In one aspect the invention provides a series of articles. In one embodiment, an article of the invention comprises a porous structure defined by pores separated by walls, where the walls comprise a composition that is substantially crystalline and that is comprised of at least 50% carbon. At least 90% of the pores have an entrance diameter with a largest cross-sectional dimension smaller than 50 nm.

In another embodiment an article of the invention comprises a porous structure having a maximum cohesive cross-sectional dimension of no less than 5 microns. The structure is free of binder upon which cohesiveness of the article is dependent, and is defined by pores separated by walls comprising a composition that is substantially crystalline. At least 90% of the pores have an entrance diameter with a largest cross-sectional dimension smaller than 50 nm.

In another embodiment an article of the invention comprises a porous structure defined by pores separated by walls comprising a composition that is substantially crystalline. At least 90% of the pores have an entrance diameter with the largest cross-sectional dimension smaller than 50 nm. The porous structure in this embodiment, has a total electrical resistivity of no higher than 20 Ohm cm.

In another aspect the invention provides a series of methods. In one embodiment, a method of making a porous solid carbon structure is provided, and involves mixing a carbon-containing precursor of the structure with an amphiphilic molecular species, polymerizing the precursor in the presence of the amphiphilic molecular species under conditions and for a period of time sufficient to define a polymerized porous carbon structure having pores occupied by the amphiphilic molecular species and with structural integrity such that, after removal of the amphiphilic molecular species, the porous structure is substantially unchanged. The method also involves carbonizing the polymerized porous carbon structure under conditions and for a period of time sufficient to remove substantially all of the amphiphilic molecular species from the material, and continuing carbonization until a desired degree of carbonization is obtained, to form a porous carbonized product having pores, substantially identical to the amphiphilic molecular species-containing polymerized porous carbon structure, defined by voids occupied by amphiphilic molecular species prior to carbonization.

In another embodiment, a method of the invention for making a porous solid carbon structure is provided and involves mixing a carbon-containing precursor with an amphiphilic molecular species to form a mixture which, if cooled to the point of at least partial solidification, exhibits x-ray diffraction peaks substantially different from those of either the amphiphilic species or carbon-containing precursor, polymerizing the precursor under conditions and for a period of time sufficient to obtain a polymerized porous structure having pores occupied by the amphiphilic molecular species and with structural integrity such that, after removal of the amphiphilic molecule, the porous structure is substantially maintained, carbonizing the polymerized porous structure at a temperature and a period of time sufficient to remove substantially all of the amphiphilic molecular species from the material, and continuing carbonization until a desired degree of carbonization is obtained.

In another embodiment a method of the invention, for making a porous solid carbon structure involves mixing a carbon-containing precursor with an amphiphilic molecular species in the presence of no auxiliary solvent or less than 25 wt % auxiliary solvent based on the total weight of the mixture, polymerizing the precursor to obtain a substantially mesoporous structure having pores occupied by the amphiphilic molecular species and with structural integrity such that, after removal of the amphiphilic molecule, the porous structure is substantially maintained, carbonizing the polymerized porous structure at a temperature and a period of time sufficient to remove substantially all of the amphiphilic molecular species from the material, and continuing carbonization until a desired degree of carbonization is obtained.

Other advantages, features, and uses of the invention will become apparent from the following detailed description of non-limiting embodiments of the invention when considered in conjunction with the accompanying drawings, which are schematic and which are not intended to be drawn to scale. In the figures, each identical or nearly identical component that is illustrated in various figures typically is represented by a single numeral. For purposes of clarity, not every component is labeled in every figure, nor is every component of each embodiment of the invention shown where illustration is not necessary to allow those of ordinary skill in the art to understand the invention. In cases where the present specification and a document incorporated by reference include conflicting disclosure, the present specification shall control. The subject matter of this application may involve, in some cases, interrelated products, alternative solutions to a particular problem, and/or a plurality of different uses of a single system or article.

### DETAILED DESCRIPTION OF THE INVENTION

The present invention provides a variety of techniques for making porous structures, and a variety of structures that can be made by these techniques. Structures of the invention can exhibit one or more of electrical conductivity, net-shape formability, unique porosity and structural crystallinity, or other features. Materials and structures of the invention, and techniques of the invention for producing materials and structures, can find commercially important applications in fields such as adsorption, separation, catalysis, electrochemistry, and electrochemical double-layer capacitor fabrication.

One method of the invention involves mixing a carbon-containing precursor and an amphiphilic molecular species to form a structure that can provide order, eventually defining voids in the final product, polymerizing the carbon precursor, and carbonizing the polymerized product to form a porous structure in which the pores are defined by removal of the amphiphilic molecular species from the mixture. As used herein, “carbon-containing,” or simply “carbon” are synonymous, that is, each term defines a composition or article that includes some carbon, and may be made entirely of carbon. Embodiments of the invention in which carbon materials are used or produced with varying degrees of carbon content are described in greater detail below.

In one embodiment, the amphiphilic molecular species and carbon-containing precursor material are first mixed in the absence of any auxiliary solvent, or in the presence of auxiliary solvent defining no more than about 10 wt %, no more than 5 wt %, or no more than 2 wt % of the total weight of the mixture (including any auxiliary solvent). “Auxiliary solvent” in this context, means solvent added to the amphiphilic molecular species and carbon-containing precursor, and does not include, by definition, any solvent-like material that may result from reaction of the carbon-containing precursor and amphiphilic molecular species during the method. Optionally, swelling agents, typically used in surfactant-templated synthesis, can be added to the amphiphilic molecular species and carbon-containing precursor solution as an additional tool to control the porosity of the final material. The carbon-containing precursor and amphiphilic molecular species can be mixed together in a variety of ratios, and generally are mixed in a ratio in which one of the species is present in an amount of at least 5 wt % based upon the weight of the entire mixture. In other embodiments each of these two components are present in an amount of at least 10, 20, or 30 wt % based on the total weight of the mixture. The components can be present in a ratio of about 1:1 relative to each other in one arrangement.

In one set of embodiments, a carbon-containing precursor which can be polymerized in the presence of a catalyst is used, and catalyst is added to the mixture. In this case, catalyst can be added to the mixture initially, or the mixture can be heated to some extent above ambient temperature, and optionally stirred, and catalyst added after some heating has occurred. For example, the mixture can be heated to about 35° C., 40° C., 50° C., or 60° C., and then catalyst can be added. In another arrangement, the mixture can be heated to these, or different temperatures, then cooled slowly, with catalyst added just before the mixture shows signs of solidification (when the formation of crystalline species is just beginning to be visible to the human eye, which is a characteristic of the technique according to one set of embodiments). In another arrangement, the mixture might not be cooled in the process of making a product, but the process is carried out such that, if the mixture were cooled, after gentle heating at one of the above temperatures in the absence or presence of catalyst, to at least the point of partial solidification, X-ray diffraction (XRD) peaks substantially different from those of either the amphiphilic species or the carbon-containing precursor would be detectable, evidencing some crystalline species formation.

With or without cooling, polymerization then occurs in this embodiment. It can be advantageous to monitor the temperature during this phase and to maintain the temperature of the mixture just higher than solidification temperature during the polymerization process. Some polymerization processes can be exothermic or endothermic, and will require changes in the amount of heat added to or withdrawn from the mixture to maintain the temperature just above solidification temperature, if this is desired. Maintaining the polymerization temperature just above the mixture's solidification temperature can be useful in preventing detrimental effects of an exothermic reaction. For example, if a reaction as described is heated at a temperature that is too high, and the reaction is exothermic, heat can increase to an undesirable level, causing the reaction to fail. Conditions such as these can be selected by those of ordinary skill in the art dependent upon materials selected.

It is advantageous, during initial polymerization of the carbon-containing precursor, to maintain the temperature below the point at which a significant amount of amphiphilic molecule would leave the system, for example due to vaporization. In this regard, it can be advantageous to maintain the temperature, during initial polymerization, below the boiling point of the amphiphilic molecule. In this arrangement, polymerization is carried out below this select temperature (e.g., boiling point of the amphiphilic molecule), for a period of time sufficient to define a polymerized porous carbon structure having pores occupied by the amphiphilic molecular species, with a sufficient degree of structural integrity to carry out the process as further described. In one embodiment, the structural integrity is sufficient such that, after removal of the amphiphilic molecule, the porous structure is substantially unchanged and results in a similar or identical porous structure in the final product. The meaning of this will become more apparent from the following description.

In one set of embodiments, polymerization is allowed to occur for a period of time such that the resultant product is self-supporting, yet without appreciable loss of the amphiphilic molecular species, e.g., with loss of no amphiphilic molecular species or loss of this species in an amount of no more than 5%, 10%, 15%, 25%, or 30% as compared to the amount of the species initially present in the mixture. That is, at this stage the material has macroscopic structural integrity such that it can be placed on a surface, without support of a container, under ambient conditions, and will not change in shape within a twenty-four hour period to an extent detectable by a human upon observation, with retention of amphiphilic molecular species as described above. In one embodiment, at this stage the product will not flow appreciably or not flow at all as determined by standard structural measurements. Polymerization, in this arrangement, also can occur until there is at least some degree of crystallinity evident in the carbon material present, i.e., at least some small crystal domains are present as identified via transmission election microscopy (TEM), scanning electron microscopy (SEM) and/or X-ray diffraction (XRD). In some embodiments significant crystallinity can be present at this stage.

Typically, polymerization to the stage thus far described takes place within a container which serves the purpose either to simply contain the material which initially was a fluid, or additionally serves the purpose of forming the material into a desired shape. At this stage, the material can be removed from the container, optionally by destroying the container around the material (e.g., cutting, tearing, or otherwise breaking the container to remove it from the material). If so desired, the mold can also be removed by physical or chemical methods, even after the carbonization treatment. There also exists the possibility of making carbonaceous replicas of a variety of materials by soaking or coating them with the carbon precursor solution, and allowing polymerization and carbonization of the composite material. Finally, the thusly-shaped material carries its shape into a final, carbonized product described more fully below. In other arrangements, for example where smaller articles are desired, the article can be broken into pieces, or even pulverized or ground to form a powder.

The process as described thus far defines a stage at which, in one embodiment, polymerized carbon-containing precursor has sufficient structural integrity such that it can be removed from any container (or the container can be removed from it), and further heated to undergo carbonization under conditions which the container might not survive (e.g., the container might become undesirably attached to the product, e.g., melted). At this stage, prior to heating to cause carbonization, the polymerized porous carbon structure contains pores at least 80%, 90%, or, in some embodiments, substantially completely occupied by the amphiphilic molecular species. As mentioned, the polymerized article at this point has structural integrity such that it is self-supporting, and this same structural integrity can result in maintenance of good porosity, as described below.

It is to be understood that this stage of the process need not define a stopping point in the process, that is, the polymerized product need not be cooled, removed from a container, re-shaped by breaking or grinding, etc. Instead, the process described thus far and the process described below can define a continuous process without an intermediate cooling, or stopping point. In such an arrangement, the initial carbon-containing precursor and amphiphilic molecular species fluid mixture generally will be supported in a container which can tolerate the process described below without damage to the final product and/or container.

In most embodiments of the invention, carbonization is then carried out by heating the polymerized carbon-containing precursor under conditions sufficient to cause carbonization. Typically, these conditions involve heating the precursor in an inert atmosphere (nitrogen, argon, or the like) at a temperature sufficient to expel the amphiphilic molecular species from the precursor, and to drive off a substantial portion (or all) non-carbon molecules from the precursor within a time period sufficient to do so (which can be easily monitored), where the temperature is low enough to maintain desired porosity in the resultant carbonized product. By “desired porosity,” it is meant whatever porosity is desired by the end user, and this can be tailored by appropriate selection of synthesis conditions. For example, carbonization might take place at 600, 800, or 1000° C. for several hours, for example 2, 4, 6 hours, or the like. Where, for example, carbonization at 800° C. for at least about 4 hours results in expulsion of 90%, 95%, or substantially all of the amphiphilic molecular species and results in carbonization such that no more than 2% by weight of the final product is non-carbon molecules, heating at a much higher temperature, such as 2200° C., could adversely effect porosity. For example, the material could undergo some collapse or other process resulting in less porosity, or the like. This may be the case even though, at higher temperatures, some other advantage may be achieved such as increase in electrical conductivity of the material, or the like. Thus, the carbonization temperature and time can be chosen, by those of ordinary skill in the art, to result in a desired balance of porous characteristic and other properties. Those of ordinary skill in the art can readily select these conditions. The temperature typically is significantly higher than the boiling point of the amphiphilic molecular species, and might advantageously be selected to be at the minimum temperature sufficient to cause desired carbonization. This often can result in desired porosity, although carbonization may take longer at this temperature.

In one embodiment, carbonization conditions are selected so as to remove substantially all of the amphiphilic molecular species and to result in carbonization such that less than 10%, 5%, or even 2% of the resulting material, by weight, is non-carbon molecules, and the material has desirable properties such as electrical conductivity, crystallinity, and the like, but conditions are gentle enough (sufficiently low temperature) such that the resultant carbonized product has pores substantially identical to the amphiphilic molecular species containing polymerized porous carbon structure, where these pores are defined by voids formerly occupied by the amphiphilic molecular species prior to carbonization.

Carbon or carbon-containing product, which is recovered after carbonization, typically is recovered in high yield according to techniques of the invention. For example, the product may have a mass equal to at least 10%, 15%, 20%, 25%, 30%, 40%, 50%, or more of the total mass of all starting materials used in the process. These starting materials include everything initially mixed together prior to polymerization, including the carbon-containing precursor, amphiphilic molecular species, and any other species used in the mixture, including any solvent.

In another aspect, the invention provides a series of products, which can be produced by methods described herein. Products of the invention are generally porous, carbon-containing structures that include one or more of the following features: specific porous features, specific electrical resistivity (i.e., conductivity), specific crystallinity, net shape formability without auxiliary binder, and other features.

In one embodiment, an article of the invention is a porous structure defined by pores separated by walls, where the walls comprise a composition that is substantially crystalline. “Substantially crystalline,” as used herein, means that the walls will exhibit electron diffraction patterns as measured by TEM that are substantially different from non-crystalline carbon or other non-crystalline material. In another embodiment, the porous structure is defined by at least 50% carbon. In another embodiment the porous structure is such that at least 90% of the pores have an entrance diameter with a largest cross-sectional dimension smaller than 50 nm. In another embodiment the structure defines an article having a total electrical resistivity no higher than 20 Ohm.cm. In another embodiment, the structure is self-supporting to the extent that it has a maximum cohesive cross-sectional dimension of no less than 5 microns, free of binder upon which the cohesiveness of the article is dependent. Any of these features can be provided in any combination in structures or articles of the invention, alone or in combination with other features described below. “Free of binder upon which cohesiveness of the article is dependent” will be readily understood by those of ordinary skill in the art to mean that the porous structure does not include auxiliary material (i.e., material present in an amount less than 20% by weight of the overall bulk of the porous structure, and of a different chemical composition than the bulk of the overall porous structure, whose primary purpose is adding structural integrity to the material), without which the article would not be cohesive and self-supporting. Binders are well-known to those of ordinary skill in the art for use in processes similar to those described herein, and it is a feature of the invention that they are not needed in some embodiments.

Carbon-containing structures of the invention, as noted above, typically include at least 50% by weight carbon. Other carbon-containing products of the invention can include at least 60%, 70%, 80%, 90%, 95%, 98%, 99%, or 99.5% by weight carbon. Where high carbon content is achieved, non-carbon material can include metals, magnetic materials, catalytic materials, and intended or residual non-carbon functional groups such as —OH, —COOH, oxides, adsorbed water and the like. In some embodiments, these auxiliary groups are substantially removed during carbonization to achieve one of above carbon-containing levels.

Crystalline materials of the invention will exhibit x-ray diffraction or electron diffraction patterns typical of such materials. Generally, the crystal lattice of such materials will be observable by electron microscopy, in at least one place or essentially everywhere in the wall structure of the porous material. In one embodiment, the material exhibits at least 50% crystallinity, optionally with the walls defined by material that is at least 50% crystalline. Although it often can be difficult to measure crystallinity of a porous structure when the crystalline domains are small, especially in a structure with crystalline domains that are smaller than 100 nm, but typically 10-20 nm, those of ordinary skill in the art can do so by breaking apart the material, or observing surface-available features which are always present in any porous structure, or the like.

The structures of the invention, in embodiments exhibiting electrical conductivity, can have electrical resistivity of no more than 20 Ohm.cm., or in other embodiments no less than 10, 5, 1, 0.1, 0.01, or 0.001 Ohm.cm.

Porous structures of the invention can exhibit a variety of porosities, porosity uniformities, etc. As used herein, “porous” is meant to define materials having a plurality of pores, rather than a simply tubular structure such as nanotube. In one embodiment, at least 50% of the pores of articles of the invention have a smallest internal dimension that is at least 2 nm and no more than 50 nm. In another embodiment the average pore size of the porous article is from 3 to 60 nm, or from 5 to 50 nm, or from 5 to 30 nm. In another embodiment at least 60, 70, 80, 90, or 98% of the pores have a smallest internal dimension that is no more than 50 nm. In another arrangement, at least 50% of the pores of the porous structure are within a pore size range varying by no more than 30% from the average pore size of the article. In another arrangement, at least 60%, 70%, 80%, 90%, or 95% of the pores are within a pore size range varying by no more than 30% from the average pore size. In another embodiment, articles of the invention will exhibit porosity measurable by material density within a particular range. For example, material of the invention can have a density of at least 0.1 cc/g(cm³/g), or 0.2, 0.3, or 0.4 cc/g. One or any number of the porous characteristics described above can be present, alone, or in combination, in articles of the invention.

Although the invention can also be defined by compositions in the form of powders, net shape formability is noted above as a feature of some embodiments of the invention. Where non-powder, self-supporting structures are provided, they can define a net shape form (final product, following carbonization), having a maximum cohesive cross-sectional dimension of no less than 5 microns, 100 microns, 1 mm, 5 mm, 1 cm, 2 cm, 5 cm, or 10 cm or more. “Maximum cohesive cross-sectional dimension of no less than X” in this context, means that the article includes at least one portion which, taken in cross section (a real or imaginary slice through the product perpendicular to an axis defining the longest dimension of the article), has a dimension of at least X. By “cohesive” is meant self-supporting, i.e., the material does not change in shape as a result of its own mass.

Amphiphilic Molecular Species

As used herein, “amphiphilic molecular species” or “amphiphilic molecules,” are molecules having separate portions which have separate abilities to be compatible with different materials, one portion of the molecule having a greater affinity for the carbon-containing precursor used in the invention than the other. “Amphiphilic molecule” is a term known in the art, and this definition is not inconsistent with the art-recognized meaning. Amphiphilic molecules include, by definition, surfactants, such as cationic surfactants, anionic amphiphilic molecules, neutral surfactants, zwitterionic amphiphilic molecules, etc. In one embodiment of the invention, a neutral, or non-ionic amphiphilic molecular species is selected. Amphiphilic molecules of the invention generally will form a relatively ordered structure, generally oriented similarly with respect to the carbon-containing precursor when the amphiphilic molecular species and precursor are mixed. For example, amphiphilic molecules might have a portion with an affinity to the carbon-containing material and, when mixed with the carbon-containing precursor, can define a two-phase system, or a lamellar structure, with one phase defined by the carbon-containing precursor and the other phase defined by a collection of amphiphilic molecules each oriented with its portion having an affinity for the carbon-containing precursor toward the carbon-containing precursor. Where the method of the invention is followed, a carbonized porous product can result which contains pores substantially identical to the amphiphilic molecular species-containing portions of the polymerized but precarbonized mixture.

One set of amphiphilic molecular species suitable for use in the invention include aliphatic alcohols, that is, molecules having a general formula CH₃(CH₂)ₙOH. Typically, these are linear, long-chain alcohols. Chain length (n) can be selected to tailor porosity of the final product in methods of the invention, with longer-chain alcohols (higher n) generally resulting in product with larger pores and shorter-chain alcohols generally resulting in product with smaller pores. The chain length (n) also should be selected to provide the amphiphilic molecular species with desired properties for use in the method. Where n is too small (chains too short), the amphiphilic molecular species may not be able to form an ordered structure defining a lamellar or other structure defined by portions of carbon precursor or amphiphilic molecular species that undergoes polymerization and then carbonization to define a product with pores resulting from voids formerly occupied by amphiphilic molecular species in the ordered pre-carbonization structure. Where n is too large, pore size may be larger than desired and/or the amphiphilic molecular species may not form desired, ordered structures when mixed with the precursor. In one embodiment, the amphiphilic molecular species is selected from the above formula where n is from about 9 to about 25, or from about 13 to about 21. It is to be understood that lower n values can be selected where the polymerization of the carbon-contained precursor material is carried out at lower temperatures, so that the carbon precursor and amphiphilic molecule are mixed in a single liquid phase. Selection of n to be from about 9 to about 25, or from about 13 to about 21 is compatible with initial room-temperature mixture.

Carbon-Containing Precursor and Catalyst

Carbon-containing precursors which can be carbonized to form porous carbon structures such as those described herein can be easily selected by those of ordinary skill in the art. A wide variety of such carbon-containing precursors are known, and their polymerization, in a manner that is compatible with the present invention, is well known. Typical carbon-containing precursors include alcohols, such as furfuryl alcohol, phenols, phenolic resins, phenol formaldehydes, resorcinol formaldehydes, and the like. The following documents incorporated herein by reference, describe various suitable carbon-containing precursors: U.S. Pat. No. 5,456,868, issued Oct. 10, 1995 to Lear, et al.; Tennison, Applied Catalysis A: General, 173 (1998), 289-311.

The catalyst (when one is needed) can be selected from among any that are suitable for polymerizing the carbon precursor, and such catalysts are well-known in the art. For example, the carbon precursor can be (in pure form, or in a mixture that includes) resorcinol-formaldehyde gels, phenol-formaldehyde gels, phenolic resins, melamine-formaldehyde gels, polyacrylonitrile, petroleum pitch, some polymerized forms of sugar molecules, and furfuryl alcohol, among others, or any combination. Petroleum pitch-based carbon precursors are sometimes used without a chemical catalyst and utilize a thermal means for producing carbon structures (US Patent Applications US 2003/0129120 A1 and US 2002/0136680 A1), while phenolic resin carbon precursors can also be polymerized via thermal approaches (U.S. Pat. No. 6,024,899). Sometimes divinylbenzene carbon precursors are polymerized through the use of a free radical initiator such as azo-bis-isobutyronitrile (AIBN) prior to carbonization (U.S. Pat. No. 6,297,293), and for carbon-containing precursors of the formaldehyde and resorcinol-formaldehyde families, strong basic catalysts such as sodium carbonate or sodium hydroxide are generally selected (U.S. Pat. No. 6,297,293). Where furfuryl alcohol is the carbon precursor, paratoluene sulfonic acid, sulfuric acid and other strong acids are often preferred (U.S. Pat. No. 4,609,972). A comprehensive review of porous carbon materials using different carbon precursors and catalysts can be found in Kyotani, T. Carbon 38 (2000) 269-286. The portions of these documents disclosing carbon precursors and catalyst (if present) are incorporated herein by reference.

Screening Tests

The following screening tests can be used to select suitable carbon-containing precursor/amphiphilic molecular species combinations for use in the invention. In one set of embodiments, these components are selected to define a liquid when mixed, and this selection can be easily made based upon known chemical principles, supplier information, etc. Some combinations of these components according to the invention will form an ordered structure when mixed. For example, when mixed as a liquid (potentially heated gently to cause mixing), when a drop of the mixture is put between cross polarizer sheets, some degree of order will be observable as evidenced by the passage of light through the cross polarizers. Upon cooling to room temperature (if heated) a suitable mixture typically will form some type of an observable ordered structure such as a lamellar structure, cubic structure, hexagonal structure, or the like. This type of order generally is consistent with liquid crystalline properties and/or XRD peaks, in the mixture, that differ from the XRD pattern of either component by itself.

Even without doing this initial screening test, those of ordinary skill in the art can quite often select an amphiphilic molecular species/carbon containing precursor combination which, when mixed, will form an ordered structure, prior to doing any analysis. Such prediction generally can be made by selecting amphiphilic molecular species having a “head group” with an affinity for the carbon-containing precursor, with a “tail” (or portion of the molecule other than the head group) that will assist in defining a relatively ordered array of the molecular species, with the majority of head groups facing in the direction of the carbon-containing precursor. Typically the head groups will have an affinity for other head groups, and the tail, or remaining portion, will have an affinity for other, like portions. The amphiphilic molecular species can be selected in combination with the carbon-containing precursor, where the precursor, upon polymerization, will contain a portion that has a greater affinity for the head groups of the amphiphilic molecular species than another portion of the polymerized product, for example, an interconnected, multi-ring system where each ring includes a heteroatom (such as oxygen) with an affinity for the head group (such as —OH). Moreover, the carbon-containing precursor can be selected such that, when polymerized, it can be visualized as forming an ordered structure with itself that can lead to crystallization.

The function and advantage of these and other embodiments of the present invention will be more fully understood from the examples below. The following examples are intended to illustrate the benefits of the present invention, but do not exemplify the full scope of the invention. The full scope of the invention is to be determined by the claims and their equivalents.

### EXAMPLES

In the following examples “carbon nanofoam” is used as a term to define any and all carbon structures in accordance with the invention. Various forms of carbon nanofoam (CNF) were made, and general results are first described: Nitrogen sorption analysis indicates that typical CNF made in accordance with one set of working examples contains both micropores and mesopores, with a mean pore diameter of 2-50 nm, a narrow mesopore size distribution, a surface area of 200-500 m²/g, and a pore volume of 0.1-0.6 cm³/g. The presence of porosity and the pore sizes have also been confirmed by transmission electron microscopy (TEM), which shows that the pores are highly interconnected, giving CNF a foam-like morphology. The nitrogen adsorption-desorption isotherm shows a hysteresis loop characteristic of mesoporous foam-like materials.

The framework of CNF made accordance with this set of working examples is unique. TEM of CNF shows that the walls are comprised of crystalline, ordered lamellar domains, whose domains have a d spacing of ˜0.3 nm. This d spacing is observed in the cured CNF precursor as well as in the carbonized CNF product. The fact that the carbon crystallites are obtained from processing at temperatures as low as 200-800° C. is highly significant. Further evidence of the crystalline nature of CNF according to this set of examples is provided by its thermal stability in air to 500° C., which is considerably greater than other non-crystalline porous forms of carbon. The CNF structure according to this set of examples is also electrically conductive, which is easily determined via a potentiostat, giving conductivities of ˜0.1 S/cm; however, it should be noted that the conductivity can be tailored based upon the carbonization temperature. Due to its conductive nature, CNF according to this set of examples can also be characterized by its electrochemical double layer capacitance. It possesses a specific capacitance of 60-120 F/g or 50-96 F/cm³, and a surface capacitance of 25-35 μF/cm² in a 1.0 M aqueous solution of sulfuric acid at room temperature.

The final material according to this set of examples consists of a continuous polycrystalline conductive carbon framework, with a foam-like morphology of interconnected mesopores displaying a narrow pore size distribution. The material has a porosity of at least 40% and a density of approximately 0.8 g/cm³, while retaining good mechanical strength.

The CNF synthesis strategy of these examples is based on three steps: (i) templating of a carbon precursor, furfuryl alcohol, with a long-chain aliphatic alcohol surfactant to form an ordered lamellar phase, (ii) polymerization of the templated carbon precursor by addition of a catalyst, p-toluene sulfonic acid, followed by mild curing, and (iii) carbonization of the carbon precursor and removal of the surfactant by heat treatment, usually under an inert atmosphere, to yield the final CNF material.

The synthesis begins by selecting a amphiphilic molecule, usually a long-chain aliphatic alcohol with a hydrophobic portion containing 7-30 carbon units and at least one hydroxyl group per molecule. This amphiphilic molecule is mixed at 40° C. with furfuryl alcohol, a carbon precursor, to produce a waxy solid that can be observed as small crystals under optical microscopy. Other carbon precursor resins such as resorcinol-formaldehyde gels, phenol-formaldehyde gels, phenolic resins, melamine-formaldehyde gels, polyacrylonitrile, petroleum pitch, and some polymerizable forms of sugar molecules may also be used.

Room-temperature X-ray diffraction (XRD) patterns of the furfuryl alcohol-surfactant solid mixtures exhibit intense peaks that correspond to a well-ordered lamellar structure induced by the surfactant. Optical microscopy can be used in concert with cross-polarization techniques at room temperature to identify an ordered liquid crystalline phase that accompanies the observed XRD peaks. The XRD patterns of the mixtures, which differ substantially from those of the pure surfactants, are maintained over a broad range of surfactant concentrations from approximately 10 to 90 wt % without changing the d spacing of the lamellar structure. When aliphatic alcohol surfactants of different carbon chain lengths are mixed with furfuryl alcohol at 1:1 weight ratio, XRD patterns corresponding to lamellar mesostructure are obtained, and a systematic increase in the d spacing in the range of approximately 3-5 nm is observed with increasing surfactant chain length. Additionally, mixtures of furfuryl alcohol and pore forming agents other than aliphatic alcohol surfactants of appropriate chain length do not exhibit the characteristic XRD peaks as described above, and dense, non-porous carbon is obtained. This strongly suggests that a specific chemical interaction exists between the hydrophilic part of the surfactant and the furfuryl alcohol molecules.

Curing of the lamellar precursor is the second step of the CNF synthesis. This is accomplished by adding a small amount of p-toluenesulfonic acid, a polymerization catalyst, and slowly increasing the temperature. Other polymerization catalysts including chemical acids like sulfuric acid and trifluoroacetic acid, chemical bases like sodium carbonate and sodium hydroxide, or heat may be used. Addition of the catalyst does not alter the ordered lamellar phase, but leads to polymerization of the furfuryl alcohol. Through careful control of the polymerization rate and curing of the material, the structure becomes rigid. TEM shows that the cured precursor exhibits a crystalline structure with a lattice distance of 0.3 nm, which is very similar to the interplanar distance of graphite. This is clearly smaller than the approximately 2-5 nm d spacings of the lamellar furfuryl alcohol-surfactant precursors.

Carbonization of the cured precursor is accomplished, in these working examples, by treating the material in an inert atmosphere typically at 800° C. During this process, the surfactant is removed from the structure to produce the final CNF material. Elemental and thermal gravimetric analyses indicate that this synthesis gives a high carbon yield, with the weight of the final material obtained after carbonization being 25% of the initial 1:1 (w/w) mixture of furfuryl alcohol-surfactant mixture. Crystallinity of the final carbonized CNF material is verified by TEM and electron diffraction, and can be inferred from the high density of its walls and the greater thermal stability of CNF in air compared to other non-crystalline porous forms of carbon. The fact that crystalline domains of carbon are formed at low temperatures (between 800 and 1200° C.) provides another method to distinguish CNF from other crystalline carbon materials. The final CNF material is also electrically conductive, as measured by a potentiostat.

CNF can be obtained with a variety of macroscopic shapes, depending on the container in which it is carbonized. While the CNF precursor is still in the liquid state during the curing step, it can be poured into a mold of the desired shape to produce thin films, spheres, discs, rods, tubes and coils, etc. They can also be readily coated onto various substrates, such as cloths, felts and papers, which are burned off during carbonization, yielding bulk monoliths with the macroscopic features of the original substrate void spaces. It is also conceivable that particles of CNF could be used in accordance with well-known techniques to produce various shapes via extrusion, stamping, or other commonly used shape-forming techniques. Besides being able to mold CNF into a variety of shapes, the synthesis offers flexibility and control over various aspects of the final material. For instance, synthesis variables such as temperature, concentrations of surfactant and carbon precursor, addition of solvents, stirring rate, as well as catalyst loading can be easily manipulated. It has been shown that these variables can be varied to control the pore diameter, pore size distribution, surface area, and pore volume of the final CNF material obtained after carbonization.

Besides its structural aromaticity, the as-prepared CNF material contains few chemical functional groups, as indicated by X-ray photoelectron spectroscopy (XPS). However, the use of various chemical methods, including oxidizing agents and thermal oxidation in the presence of water, air, inert gas, or a mixture all three, can lead to the surface activation of CNF, defined here as drastically increasing the number of non-aromatic chemical entities on the CNF surface. This may be desirable for certain applications of CNF.

The synthesis described above results in a final material consisting of essentially pure carbon. However, for some applications it may be advantageous to add various fillers, modifiers, binders, and solvents to modify the properties of CNF. These additives may be introduced either before the curing step or during the curing step while CNF is in the liquid state, or may be mixed into the final carbonized material according to methods known to those skilled in the art.

Due to its interconnected and tunable porosity, high surface area, and high pore volume, CNF of the invention can be used as a catalyst support for various metals, metal oxides, and inorganic mixtures, especially when these are present as small clusters (<1 to 10 nm in diameter).

In one example, CNF was vapor-grafted with an organopalladium complex in order to deposit palladium clusters within the pores of CNF. The resulting Pd/CNF catalyst was then tested for the Heck reaction, a very useful reaction in both the fine chemical and pharmaceutical industries. The unique combination of conductivity, high surface area, interconnected mesopore morphology, and crystalline wall structure allowed the spontaneous reduction of the volatile Pd(II) complex within the CNF pores upon vapor grafting as revealed by XPS, and played a role in the stabilization of highly dispersed Pd clusters over several reaction cycles. The Pd/CNF catalysts showed very good tolerance to oxygen and water, and displayed turnover frequencies (TOF's) as high as 2,800 hr⁻¹ in the Heck coupling of 4-bromoacetophenone with n-butyl acrylate at 140° C. They were successfully reused several times even in the presence of air, while still maintaining a good TOF of 270 hr⁻¹ and a total turnover number (TON) of 18,500 after five cycles.

The initial activities of the Pd/CNF catalyst at 140° C. under argon (TOF=2,480 hr⁻¹) were comparable to the best palladium on activated carbon (Pd/C) catalysts. However, unlike most conventional catalysts, Pd/CNF did not require hydrogen pre-treatment or hydrogen reduction after catalyst recycling. TEM and XPS analyses showed that after three cycles in the presence of oxygen, the palladium cluster size remained unchanged at 2-5 nm, and that the palladium was still in its reduced Pd⁰ state on the CNF surface. Thus, CNF was able to suppress palladium cluster growth and agglomeration, and prevent oxidation of the palladium species even in the presence of oxygen. This solves two of the major problems associated with Heck catalysts, and allows the Pd/CNF catalyst to be reused effectively over multiple cycles.

The beneficial properties of Pd/CNF observed in Heck reaction are applicable to other Pd-catalyzed reactions, including hydrogenations, Suzuki cross-coupling reactions, Stille transformations, and amination reactions. CNF may also be used to support other transition metal systems, providing additional opportunities in catalysis and creating new possibilities for stabilizing metallic nanoclusters for a variety of applications.

As-synthesized CNF of the invention, which contains few surface chemical entities besides the aromaticity of the walls, can be used for separation of molecules in chromatography and in simple adsorption processes. Its mesoporosity allows facile diffusion of large molecules, proteins, and substrates throughout the structure, giving it a distinct advantage over microporous carbons. Additionally, CNF can be easily produced in the form of spherical particles in the size relevant for chromatographic separations, using similar techniques for the production of polymeric microspheres. CNF produced in accordance with the working examples further exhibits greater chemical and mechanical stabilities compared to silica chromatographic stationary phases, which often degrade at moderate to high pH values. As an adsorbent, CNF can be used in the purification of industrial liquid streams and in the removal of toxic contaminants from water, particularly in the case of bulky adsorbates.

Modification of the CNF surface can be accomplished via chemical, electrochemical, or thermal means. Because CNF of the invention exhibits conductivity, specific covalent functionalization of the carbon surface can be easily achieved via electrochemical treatment. To demonstrate the convenience of this method, 4-bromomethylphenylacetic acid (BMPAA) was anchored onto the surface of the CNF with the use of a simple electrochemical cell set-up. XPS analysis showed that the Br contents on the experimental and control electrodes were 0.38 and 0.06 wt %, respectively, indicating that 4-bromomethylbenzyl groups have been successfully anchored onto CNF in the experimental electrode. The resulting bromomethylphenyl moiety presents an excellent ligand for further CNF surface functionalization via various nucleophilic substitution reactions.

The ease with which CNF can be electrochemically grafted provides a simple and direct method to introduce and/or immobilize enzymatic, chiral or achiral organometallic catalytic complexes within its porous framework. The absence of —OH moieties on the CNF surface presents a major advantage over conventional oxide supports, since it does not have the undesirable interactions between catalyst active sites and oxide surface groups. The facile electrochemical surface functionalization, the conductive framework, and the mesoporosity of CNF of the invention provides utility in a number of areas including the fields of separation and electrosorption.

Another application for CNF of the invention is in the area of energy storage. CNF made in accordance with the working examples of the invention as shown to exhibit capacitance values as high as 120 F/g, which are among the highest values reported for unmodified carbon materials. It also displayed nearly ideal cyclic voltammetry (CV) behavior over the wide range of scan rates (1-25 mV/sec). The large capacitance values and desirable CV curve shapes at high scan rates suggested that the electrolyte molecules can easily diffuse throughout the CNF electrode. Taking into consideration its density (0.8 g/cm³), CNF has a volumetric capacitance of 96 F/cm³, which makes it an excellent choice for use as supercapacitors in small, compact devices. CNF's surface capacitance of 30 μF/cm² is much larger than that displayed by activated carbon, carbon aerogels, carbon black, and carbon nanotubes, and approaches that of pure graphite, providing evidence that nearly all of the CNF surface area may contribute to the capacitance of this new electrode material.

### Example of CNF Capacitor

A simple, compact working device with two electrodes weighing 10 mg each and consisting of CNF made in accordance with the invention was constructed by immersion in a solution of 1 M tetraethylammonium tetrafluroborate in propylene carbonate, separated by a porous membrane. This CNF supercapacitor prototype was tested along with a traditional 4700-μF electrolytic capacitor by charging both capacitors from the same battery source at 3.5 V, and then discharging through two equivalent LED-resistor combinations that were connected to each capacitor in isolated circuits. The runs were stopped when the LED ceased to illuminate, which corresponded to voltages below 1.74 V. The CNF supercapacitor maintained a voltage sufficient to light its LED 54 times longer than the 4700-μF electrolytic capacitor, even though it is 100 times smaller in volume.

Although not wishing to be bound by any theory, the inventors believe the following principles may be responsible for their ability to form carbonized, porous material with pores substantially identical to voids filled by amphiphilic molecular species prior to carbonization.

We note that the synthesis of CNF is very different from the supramolecular templating of mesoporous M41S type of materials. Although the first stage of the CNF synthesis involves the templating of the furfuryl alcohol precursors by the aliphatic alcohol surfactants, the resulting lamellar mesostructure with a d spacing of >3 nm was disrupted during the curing process. As the furfuryl alcohol precursors began to polymerize with the addition of p-toluene sulfonic acid, their interaction with the surfactants became weaker. The aliphatic alcohol surfactants left the lamellar mesostructure, allowing polyfurfuryl chains to align into new crystalline domains with a d spacing of ˜0.3 nm. The surfactant molecules became aggregated in pockets of roughly the same diameter as the nanopores observed in the final CNF, surrounded by an increasingly hydrophobic framework of polyfurfuryl chains. Upon carbonization, a nanocrystalline carbon framework with a d spacing of ˜0.3 nm was obtained, and the material displayed a porous network that resulted from the removal of surfactant species. The chain length of the surfactant species affected the average mesopore size, but the absence of a well-ordered mesostructure during carbonization led to a less well-defined mesoporous structure in CNF compared to M41S type of materials. The latter preserved its micelle-templated mesostructure during surfactant removal, and hence possessed a very narrow pore size distribution with well-defined pore ordering.

### Example: Synthesis of Carbon Nanofoam

In a typical synthesis, 5 g of hexadecanol and 5 g of furfuryl alcohol were mixed and slowly heated until a clear yellow solution was obtained, at which time 0.15 g of para-toluene sulfonic acid solution (60% w/w in water) was added. If a particular macroscopic shape was required, the carbon nanofoam (CNF) precursor solution was transferred at this point to a sealed container of desired shape, and the remainder of the synthesis was carried out in this container. The temperature was kept constant at 40°-50° C. to avoid both the solidification of the solution and to accelerate the rate of furfuryl alcohol polymerization.

The solution color changed from yellow to dark green and finally brown. The solution temperature was then ramped to 80° C. to avoid solidification under stirring and finally to 100° C. and 120° C. for curing, after which the carbon precursor could be cut or ground down into a powder if needed. The material was heat treated in nitrogen for 5 h at 800° C.

The obtained material had a Braunauer-Emmett-Teller (BET) surface area of 400 m²/g, pore volume of 0.4 cm³/g, median pore diameter of 8 nm as measured by nitrogen adsorption, and a crystal lattice spacing of 0.3 nm as measured by transmission electron microscopy (TEM). The carbonized material typically has a conductivity of about 0.2 S/cm (Siemens/cm).

### Example: Another Synthesis of Carbon Nanofoam

In a typical synthesis, 0.5 g of hexadecanol and 5 g of furfuryl alcohol were mixed and slowly heated until a clear yellow solution was obtained, at which time 0.05 g of para-toluene sulfonic acid solution (60% w/w in water) was added. If a particular macroscopic shape was required, the CNF precursor solution was transferred at this point to a sealed container of desired shape, and the remainder of the synthesis was carried out in this container. The temperature was kept constant at 40°-50° C. to avoid both the solidification of the solution and to accelerate the rate of furfuryl alcohol polymerization.

The solution color changed from yellow to dark green and finally brown. The solution temperature was then ramped to 80° C. to avoid solidification under stirring and finally to 100° C. and 120° C. for curing, after which the carbon precursor could be cut or ground down into a powder if needed. The final material was heat treated in nitrogen for 5 h at 600° C.

The final obtained from this synthesis had a Brunauer-Emmitt-Teller (BET) surface area of 280 m²/g, pore volume of 0.36 cm³/g, median pore diameter of 8 nm as measured by nitrogen adsorption, and a crystal lattice spacing of 0.3 nm as measured by transmission electron microscopy (TEM).

### Example: Another Synthesis of Carbon Nanofoam

In a typical synthesis, 5 g of hexadecanol and 0.5 g of furfurfyl alcohol were mixed and slowly heated until a clear yellow solution was obtained, at which time 0.25 g of para-toluene sulfonic acid solution (60% w/w in water) was added. If a particular macroscopic shape was required, the CNF precursor solution was transferred at this point to a sealed container of desired shape, and the remainder of the synthesis was carried out in this container. The temperature was kept constant at 40°-50° C. to avoid both the solidification of the solution and to accelerate the rate of furfuryl alcohol polymerization.

The solution color changed from yellow to dark green and finally brown. The solution temperature was then ramped to 80° C. to avoid solidification under stirring and finally to 100° C. and 120° C. for curing, after which the carbon precursor could be cut or ground down into a powder if needed. The final material was heat treated in nitrogen for 12 hours at 2200° C.

Even after the very high carbonization temperature treatment, the final obtained from this synthesis had a Brunauer-Emmitt-Teller (BET) surface area of 100 m²/g, pore volume of 0.18 cm³/g, median pore diameter of 8 nm as measured by nitrogen adsorption, and a crystal lattice spacing of 0.3 nm as measured by transmission electron microscopy (TEM).

### Example: Ability to Vary d-Spacing of Carbon Precursor/Amphiphile Mixture

The templating effect of the amphiphilic molecule could be characterized in several ways. One particular method involves heating furfuryl alcohol, a carbon precursor, and the amphiphile at a temperature just above the melting point of the amphiphilic molecule. Upon cooling to room temperature, a solid was obtained. X-ray diffraction (XRD) of the solid mixture revealed an ordered solid phase, as observed by the presence of several peaks that differed substantially from the x-ray diffractoframs of either the pure amphiphilic molecule or carbon precursor. The peaks suggest a lamellar-ordered phase, and the d-spacing of the ordered phase can be calculated by methods well known to those skilled in the art.

### Example: Amphiphilic Molecules

In this example five amphiphilic molecules were examined, tetradecanol, hexadecanol, octadecanol, eicosanol, and docosanol, and were mixed in 1:1 weight ratios with furfuryl alcohol. These mixtures were heated and cooled to room temperature. The d-spacings obtained from the XRD analysis can be seen in Table 1.

TABLE 1
Effect of amphiphile chain length on the d spacing of the lamellar
mesostructure of furfuryl alcohol-surfactant mixtures.

| Amphiphile | d spacing (nm) |
|---|---|
| C₁₄H₂₉OH | 3.39 |
| C₁₆H₃₃OH | 3.68 |
| C₁₈H₃₇OH | 4.20 |
| C₂₀H₄₁OH | 4.65 |
| C₂₂H₄₅OH | 4.90 |

### Example: Effect of Amphiphile Templating Agent Choice on CNF Pore Size

All of the conditions of the first example of forming nanofoam were followed, except that the length of the hexadecanol chain was varied by choosing different amphiphiles to obtain varying pore sizes in the final material. Three amphiphiles were studied, hexadecanol, octadecanol and docosanol. C₁₆H₂₉OH (hexadecanol) produces a median pore size of 8 nm, C₁₈H₃₇OH (octadecanol) gives a median pore size of 10 nm, and C₂₂H₄₅OH (docosanol) produces a median pore size of 20 nm. The absence of any amphiphile led to non-porous, non-crystalline carbon with very low surface area <20 m²/g.

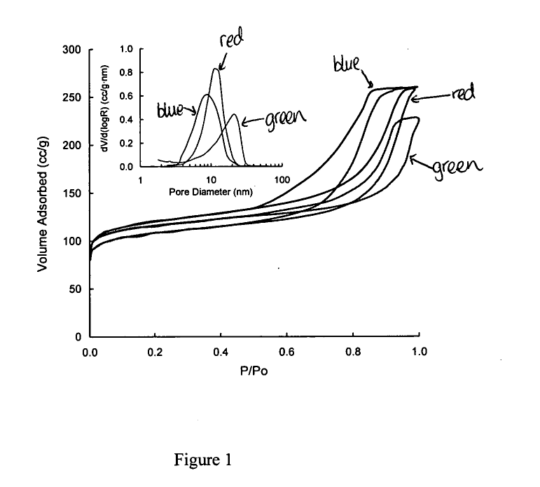

After carbonization at 800° C., the following isotherms and pore size distributions (calculated from the adsorption isotherm branch) were measured using nitrogen sorption (see FIG. 1).

### Example: Ability to Tune the Conductivity of Carbon Nanofoam

All of the conditions of the first example of forming a nanofoam were followed, except that carbonization temperature. If low carbonization temperatures were used, i.e. below 600° C., final materials with conductivities less than 1 μS/cm were obtained. However, as the carbonization temperature raises, the conductivity of the final material increased, reaching values of 10 μS/cm at 700° C., increasing quickly to 0.2 S/cm (Siemens/cm) at 800° C. and even 5.0 S/cm when carbonization temperatures higher than 1000° C. were used.

### Example: Ability to Mold Carbon Nanofoam Materials into Macroscopic Shapes

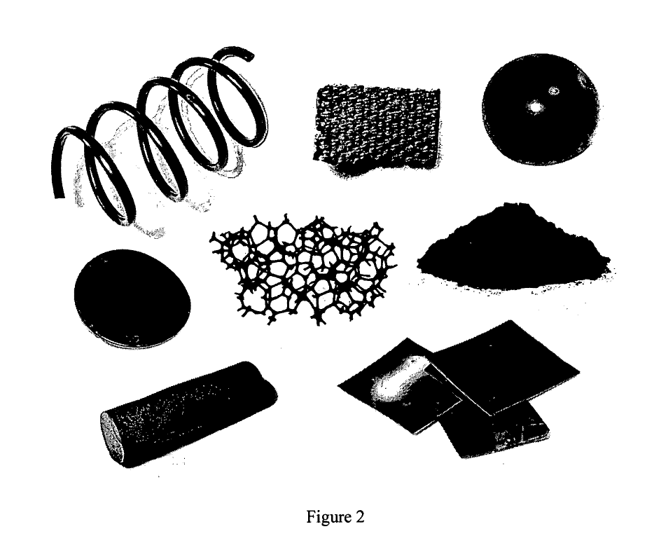

The synthesis outlined in the first example of forming a nanofoam was followed. After addition of the polymerization catalyst, the CNF liquid precursor solution could simply by poured into a container of desired shape. The materials were cured and carbonized in the containers, after which time the CNF was removed from the molds by fracturing the containers. Using this scheme, a great variety of macroscopic shapes were be obtained. The container can also be a flexible shape, and if the container itself is volatile, it can simply be removed during carbonization. A few examples of various shapes made accroding to this example include a spring, woven fiber, ball, rod, plate, and powder (See FIG. 2).

### Example: Mixtures of CNF and other Materials

If desired, a number of other materials can be incorporated into the CNF synthesis scheme. As one example, magnetic nanoparticles of iron oxides were incorporated into the CNF framework. The synthesis scheme of the first example of forming a nanofoam was followed, where the magnetic nanoparticles at 10 wt % based on furfuryl alcohol were added to the solution before curing. The particles remained dispersed in the liquid phase through vigorous stirring. The cured solid CNF-magnetic nanoparticle composite was carbonized to 400° C. The final material exhibited the normal porosity of CNF and a net magnetic moment, as measured by SQUID magnetic scanner.

While several embodiments of the invention have been described and illustrated herein, those of ordinary skill in the art will readily envision a variety of other means and structures for performing the functions and/or obtaining the results or advantages described herein, and each of such variations or modifications is deemed to be within the scope of the present invention. More generally, those skilled in the art would readily appreciate that all parameters, dimensions, materials, and configurations described herein are meant to be exemplary and that actual parameters, dimensions, materials, and configurations will depend upon specific applications for which the teachings of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, material and/or method described herein. In addition, any combination of two or more such features, systems, materials and/or methods, if such features, systems, materials and/or methods are not mutually inconsistent, is included within the scope of the present invention.

In the claims (as well as in the specification above), all transitional phrases such as “comprising”, “including”, “carrying”, “having”, “containing”, “involving”, “composed of”, “made of”, “formed of” and the like are to be understood to be open-ended, i.e. to mean including but not limited to. Only the transitional phrases “consisting of” and “consisting essentially of” shall be closed or semi-closed transitional phrases, respectively, as set forth in the United States Patent Office Manual of Patent Examining Procedures, section 2111.03.

1. An article comprising a porous structure defined by pores separated by walls, the walls comprising a composition that is substantially crystalline and that is comprised of at least 50% carbon, at least 90% of the pores having an entrance diameter with a largest cross-sectional dimension smaller than 50 nm.

2. An article as in claim 1, wherein the porous structure comprises at least 70% carbon by weight.

3. An article as in claim 1, wherein the porous structure comprises at least 80% carbon by weight.

4. An article as in claim 1, wherein the porous structure comprises at least 90% carbon by weight.

5. An article as in claim 1, wherein the porous structure comprises at least 95% carbon by weight.

6. An article as in claim 1, wherein the porous structure comprises at least 98% carbon by weight.

7. An article as in claim 1, wherein, of all carbon contained in the porous structure, at least 50% of the carbon exhibits electron diffraction typical of crystalline material, and has a crystal lattice observable by electron microscopy within walls structure.

8. An article as in claim 1, wherein all carbon in the structure is at least 50% crystalline.

9. An article as in claim 1, wherein walls of the structure are defined by material that is at least 50% crystalline.

10. An article as in claim 1, wherein the porous structure has an electrical resistivitiy of no more than 20 Ohm.cm.

11. An article as in claim 1, wherein the porous structure has an electrical resistivity of no more than 1 Ohm.cm.

12. An article as in claim 1, wherein the porous structure has an electrical resistivity of no more than 0.01 Ohm.cm.

13. An article as in claim 1, wherein the porous structure has an electrical resistivity of no more than 0.001 Ohm.cm.

14. An article as in claim 1, wherein at least 50% of all pores in the structure have a smallest internal diameter that is at least 2 nm and that is no more than 50 nm.

15. An article as in claim 1, wherein the average pore size throughout the porous structure is from 3 to 60 nm.

16. An article as in claim 1, wherein the average pore size throughout the porous structure is from 5 to 50 nm.

17. An article as in claim 1, wherein the average pore size throughout the porous structure is from 5 to 30 nm.

18. An article as in claim 17, wherein at least 98% of all pores of the porous structure have a smallest internal dimension that is no more than 50 nm.

19. An article as in claim 1, wherein at least 98% of all pores of the porous structure have a smallest internal dimension that is no more than 50 nm.

20. An article as in claim 1, wherein at least 50% of all pores in the porous structure have a pore size range varying by no more than 30% from the average pore size of the structure.

21. An article as in claim 1, wherein at least 60% of all pores in the porous structure have a pore size range varying by no more than 30% from the average pore size of the structure.

22. An article as in claim 1, wherein at least 70% of all pores in the porous structure have a pore size range varying by no more than 30% from the average pore size of the structure.

23. An article as in claim 1, wherein at least 80% of all pores in the porous structure have a pore size range varying by no more than 30% from the average pore size of the structure.

24. An article as in claim 1, wherein the porous structure has a total pore volume of at least 0.1 cc/g.

25. An article as in claim 1, wherein the porous structure has a total pore volume of at least 0.2 cc/g.

26. An article as in claim 1, wherein the porous structure has a total pore volume of at least 0.3 cc/g.

27. An article as in claim 1, wherein the porous structure has a total pore volume of at least 0.4 cc/g.

28. An article as in claim 1, wherein the porous structure has a maximum cohesive cross-sectional dimension of no less than 5 microns.

29. An article as in claim 1, wherein the porous structure has a maximum cohesive cross-sectional dimension of no less than 100 microns.

30. An article as in claim 1, wherein the porous structure has a maximum cohesive cross-sectional dimension of no less than 1 mm.

31. An article as in claim 1, wherein the porous structure has a maximum cohesive cross-sectional dimension of no less than 5 mm.

32. An article as in claim 1, wherein the porous structure has a maximum cohesive cross-sectional dimension of no less than 1 cm.

33. An article as in claim 1, wherein the porous structure has a maximum cohesive cross-sectional dimension of no less than 2 cm.

34. An article as in claim 1, wherein the porous structure has a maximum cohesive cross-sectional dimension of no less than 5 cm.

35. An article as in claim 1, wherein the porous structure has a maximum cohesive cross-sectional dimension of no less than 10 cm.

36. An article as in claim 1, wherein the porous structure has a smallest cohesive cross-sectional dimension of no less than 5 microns.

37. An article comprising a porous structure having a maximum cohesive cross-sectional dimension of no less than 5 microns, free of binder upon which the cohesiveness of the article is dependent, defined by pores separated by walls comprising a composition that is substantially crystalline, at least 90% of which pores have an entrance diameter with a largest cross-sectional dimension smaller than 50 nm.

38. An article as in claim 37, wherein the porous structure comprises at least 50% carbon.

39. An article as in claim 37, wherein the porous structure has a total electrical resistivity of no higher than 20 Ohm.cm.

40. An article comprising a porous structure defined by pores separated by walls comprising a composition that is substantially crystalline, at least 90% of which pores have an entrance diameter with a largest cross-sectional dimension smaller than 50 nm, the porous structure having a total electrical resistivity no higher than 20 Ohm.cm.

41. A method of making a porous solid carbon structure, comprising:
mixing a carbon-containing precursor of the structure with an amphiphilic molecular species;
polymerizing the precursor in the presence of the amphiphilic molecular species under conditions and for a period of time sufficient to define a polymerized porous carbon structure having pores occupied by the amphiphilic molecular species and with structural integrity such that, after removal of the amphiphilic molecular species, the porous structure is substantially unchanged;
carbonizing the polymerized porous carbon structure under conditions and for a period of time sufficient to remove substantially all of the amphiphilic molecular species from the material and continuing carbonization until a desired degree of carbonization is obtained, to form a porous carbonized product having pores, substantially identical to the amphiphilic molecular species-containing polymerized porous carbon structure, defined by voids occupied by amphiphilic molecular species prior to carbonization.

42. A method as in claim 41, comprising carbonizing the polymerized porous carbon structure at a temperature above the boiling point of the amphiphilic molecular species.

43. A method as in claim 41, comprising polymerizing the precursor under conditions in which the amphiphilic molecular species is substantially retained in the pores.

44. A method as in claim 41, comprising polymerizing the precursor at a temperature below the boiling point of the amphiphilic molecular species.

45. A method as in claim 41, comprising polymerizing the precursor in the presence of a polymerization catalyst.

46. A method as in claim 41, wherein the porous carbonized product has pores, at least 90% of which have an entrance diameter with a largest cross-sectional dimension smaller than 50 nm.

47. A method as in claim 41, comprising polymerizing the precursor for a period of time sufficient to define at least some crystallinity in the carbon while maintaining substantially all of the amphiphilic molecular species in combination with the precursor.

48. A method as in claim 41, wherein the amphiphilic molecular species does not undergo chemical reaction during the method.

49. A method as in claim 41, wherein the porous carbonized product has a mass equal to at least 10% of the total mass of all starting materials involved in the method.

50. A method as in claim 41, wherein the porous carbonized product has a mass equal to at least 15% of the total mass of all starting materials involved in the method.

51. A method as in claim 41, wherein the porous carbonized product has a mass equal to at least 20% of the total mass of all starting materials involved in the method.

52. A method as in claim 41, wherein the porous carbonized product has a mass equal to at least 25% of the total mass of all starting materials involved in the method.

53. A method as in claim 41, wherein the porous carbonized product has a mass equal to at least 30% of the total mass of all starting materials involved in the method.

54. A method as in claim 41, wherein the method is carried out in the absence of any solvent that is not a byproduct of any reaction involved in the method.

55. A method as in claim 41, wherein the porous carbonized product comprises a porous structure defined in claim 1.

56. A method as in claim 41, wherein the porous carbonized product comprises a porous structure as defined in claim 37.

57. A method as in claim 41, wherein the porous carbonized product comprises a porous structure as defined in claim 40.

58. A method of making a porous solid carbon structure, comprising:
mixing a carbon-containing precursor with an amphiphilic molecular species to form a mixture which, if cooled to the point of at least partial solidification, exibits x-ray diffraction peaks substantially different from those of either the amphiphilic species or carbon-containing precursor;
polymerizing the precursor under conditions and for a period of time sufficient to obtain a polymerized porous structure having pores occupied by the amphiphilic molecular species and with structural integrity such that, after removal of the amphiphilic molecule, the porous structure is substantially maintained;
carbonizing the polymerized porous structure at a temperature and a period of time sufficient to remove substantially all of the amphiphilic molecular species from the material and continuing carbonization until a desired degree of carbonization is obtained.

59. A method of making a porous solid carbon structure, comprising:
mixing a carbon-containing precursor with an amphiphilic molecular species in the presence of no auxiliary solvent or less than 25 wt % auxiliary solvent based on the total weight of the mixture;
polymerizing the precursor to obtain a substantially mesoporous structure having pores occupied by the amphiphilic molecular species and with structural integrity such that, after removal of the amphiphilic molecule, the porous structure is substantially maintained;
carbonizing the polymerized porous structure at a temperature and a period of time sufficient to remove substantially all of the amphiphilic molecular species from the material and continuing carbonization until a desired degree of carbonization is obtained.
